(19) United States
(12) Patent Application Publication
(10) Pub. No.: US 2017/0123392 A1
(43) Pub. Date: May 4, 2017

(54) System and Method for Modelling Engine Components

(71) Applicant: Caterpillar Inc., Peoria, IL (US)

(72) Inventors: Keith Troisi, Washington, IL (US); David Pierpont, Dunlap, IL (US); Raghuvansh Ramaswamy, Framingham, MA (US)

(73) Assignee: Caterpillar Inc., Peoria, IL (US)

(21) Appl. No.: 14/925,166

(22) Filed: Oct. 28, 2015

(51) Int. Cl. G05B 17/02

(52) U.S. Cl. CPC G05B 17/02

(57) ABSTRACT

A system and method configured to model an engine cylinder system is disclosed. The engine cylinder system having a plurality of components including a cylinder and a piston slideably positioned within the cylinder. The method including operating the piston to move within the cylinder, sensing a first at least one engine operating parameter during operation of the piston, and calculating a second at least one engine operating parameter based on the first at least one engine operating parameter. Based on the first at least one engine operating parameter and the second at least one engine operating parameter, a heat flux for at least one of the plurality of components and an operating cylinder pressure are calculated.

### TECHNICAL FIELD

This disclosure relates generally to a machine engine system, and more particularly, to a system and method for assessing conditions of machine engine system components during operation of the machine engine system.

### BACKGROUND

Engine systems include engine cylinder assemblies that have multiple components, including, for example, an engine cylinder, a piston, a crankshaft, a connecting rod, an inlet valve, and an exhaust valve. Each component undergoes temperature and pressure changes during the operation of the engine system, and these temperature and pressure changes impact performance of the engine system.

Current methods for determining the performance of an engine cylinder include sensing and/or simulating engine cylinder characteristics. U.S. Pat. No. 7,685,871 (hereinafter “the '871 patent”), assigned to Delphi Technologies, Inc., discloses such a method by estimating residual gas burn. The estimated residual gas burn is used to control and maximize internal dilution which increases fuel economy. The gas burn is estimated by measuring gas contents within the engine cylinder and using an iterative approach to converge on an estimated residual fraction. Current methods, such as ones described in the '871 patent, require a variety of sensors positioned in and around the engine cylinder, each of which add to the cost of the engine, increase uncertainty, and can hinder or obstruct cylinder operation if they become loose or fall off.

Thus, a simplified method for determining the performance of an engine cylinder during operation is desired to improve the performance of an engine system.

### SUMMARY

An aspect of the present disclosure provides a method configured to model an engine cylinder system. The method includes the steps of: moving a piston of the engine cylinder system within a cylinder of the engine cylinder system, during the moving step, sensing a first engine operating parameter, after the sensing step, calculating a second engine operating parameter based on the first engine operating parameter, and calculating a heat flux for at least one of a plurality of components of the engine cylinder system based on the first engine operating parameter and the second engine operating parameter.

Another aspect of the present disclosure provides an engine control module. The engine control module is operatively coupled to an engine cylinder system. The engine cylinder system has a plurality of components including a piston slideably positioned within a cylinder. The engine control module further includes at least one sensor and a processor. The at least one sensor is configured to sense a first engine operating parameter when the piston is moving within the cylinder. The processor is configured to calculate a second engine operating parameter based on the first at least one engine operating parameter, and further configured to calculate a heat flux of at least one of the plurality of components and a cylinder operating pressure based on the first at least one engine operating parameter and the second at least one engine operating parameter.

Another aspect of the present disclosure provides an engine system. The engine system includes a cylinder, a piston, and an engine control module. The piston is moveably positioned within the cylinder. The engine control module includes at least one sensor and a processor. The at least one sensor is configured to sense a first engine operating parameter while the piston is moving within the cylinder. The processor is configured to calculate a second engine operating parameter based on the first at least one engine operating parameter, and further configured to calculate a heat flux of the piston based on the first at least one engine operating parameter and the second at least one engine operating parameter.

### BRIEF DESCRIPTION OF THE DRAWINGS

FIG. 1 is a schematic view of an engine system, according to an aspect of this disclosure.

FIG. 2 is a schematic view of a controller, according to an aspect of this disclosure.

FIG. 3 is a flowchart depicting a method of modeling an engine system, according to an aspect of this disclosure.

### DETAILED DESCRIPTION

The disclosure relates generally to an engine control module configured to determine the performance of an engine system by determining a heat flux for several components of an engine cylinder system. Each heat flux is determined by data sensed and/or stored in a memory, including, for example, physical parameters of the engine cylinder, engine operating conditions, fuel properties, heat flux algorithms, and/or other parameters. Based on each heat flux, the performance of the engine system may be evaluated.

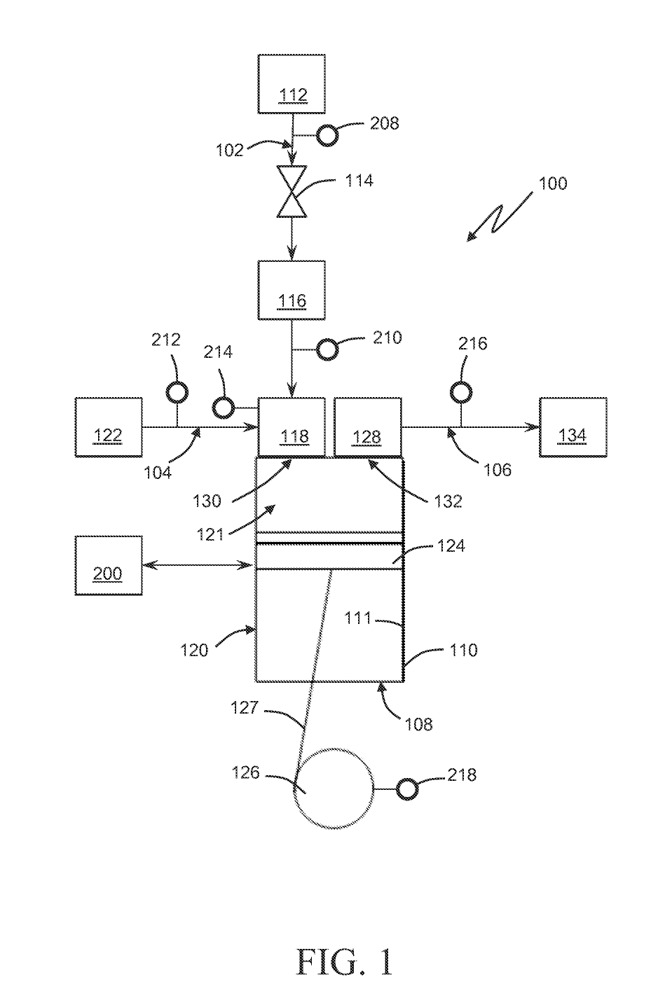

FIG. 1 illustrates a schematic of an engine system 100, according to one aspect of the disclosure. In this view, the engine system 100 includes a gas supply system 102, an air intake system 104, an exit exhaust system 106, and an engine cylinder system 108. Air and fuel flow through the air intake system 104 and the gas supply system 102, respectively, and a mixture of the air and fuel flow through the cylinder system 108 and the exhaust system 106. The cylinder system 108 includes an engine housing 120, a cylinder 110 having a cylinder liner 111 and a piston 124, an intake valve 130, and an exhaust valve 132. The cylinder liner 111 and the piston are positioned within the cylinder 110. The intake valve 130 and the exhaust valve 132 may be coupled to an inlet and an outlet of the cylinder 110, respectively. After entering the cylinder system 108, the fuel may ignite and perform work on the piston 124. After the combustion process, the exhaust gases exit along the exit exhaust system 106.

In an aspect of this disclosure, and as described herein, the gas supply system 102 is a diesel supply system. In alternative aspects, the gas supply system may include a gaseous fuel system, a natural gas fuel system, a duel fuel system, or other fuel systems commonly known in the art.

The diesel supply system 102 may include various components known and used in the art including a diesel supply tank 112, a fuel control valve or pressure regulator 114, and a fuel pump 116. The diesel supply system 102 may include other components including filters, rack control valves, relief valves, or the like, none of which are shown for clarity. The fuel pump 116 is disposed along the diesel supply system 102 downstream of the diesel fuel supply 112. The fuel pump 116 may pump diesel fuel into the cylinder 110 of the engine system 100. It should be appreciated that a rail type system (not shown), also referred to as a common rail, or a fuel manifold may be used to supply diesel fuel to the cylinder 110.

The pressure regulator 114 may receive diesel fuel from the diesel fuel supply 112 prior to or upstream of the fuel pump 116. The diesel fuel enters the fuel pump 116 under pressure from the fuel supply 112 when the pressure regulator 114 is in an open position. Within the fuel pump 116 the fuel may be selectively controlled and timed before entering an intake manifold 118 or before being directly injected into a combustion chamber 121 defined by the engine housing 120 and the piston 124. A fuel hose (not shown) may fluidly connect the fuel pump 116 and the intake manifold 118 to transport the fuel to the manifold 118. The fuel hose may be a single-wall hose, a dual-wall hose, or other suitable hose known in the art.

The air intake system 104 includes an air inlet 122 for supplying air to the intake manifold 118. Various components known and used in the art may form part of the air intake system 104 including a compressor, an aftercooler, filters, or the like. In other embodiments, the air intake system 104 may include one or more valves for various purposes including for controlling the intake pressure into the engine system 100. The intake air is combined with the gas fuel within the intake manifold 118 and provided to the engine cylinder 110 for combustion.

After the diesel fuel and/or the air flow through their corresponding supply systems, they enter the cylinder 110 through an intake valve 130. It will be appreciated that there may be additional cylinders which are not shown in FIG. 1, commonly six, eight, twelve or more cylinders, each having a piston 124 reciprocable therein to contribute to the rotation of a crankshaft 126. During a combustion process, the diesel fuel may self-ignite, thereby driving the piston 124 and inducing rotation of the crankshaft 126 via a connecting rod 127. In an alternative aspect, an ignition mechanism may be used during the combustion process.

After the combustion process, the exhaust created during combustion flows out of the cylinder 110, along the exhaust system 106 through an exhaust valve 132 to an exhaust manifold 128 and to an exhaust outlet 134.

To facilitate control and coordination of the engine system 100, the engine system 100 may include an engine control module (ECM) 200, which may be used to facilitate control and coordination of any methods or procedures described herein. The ECM 200 may be an electronic control unit, system computer, central processing unit, or other data storage manipulation device that may be used to facilitate control and coordination and to assess various components of the engine system 100. While the ECM 200 is represented as a single unit coupled to the cylinder system 108, in other aspects the ECM 200 may be distributed as a plurality of distinct but interoperating units, incorporated into another component, or located at different locations on or off the engine system 100.

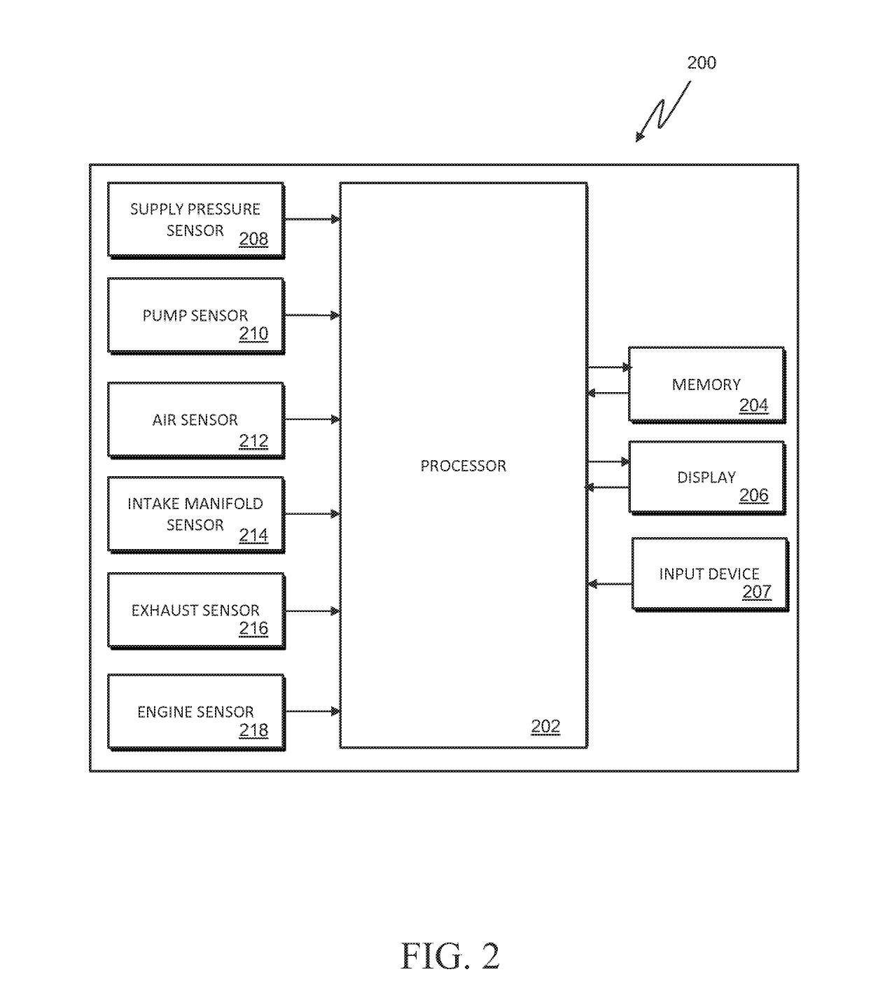

FIG. 2 illustrates a schematic of the ECM 200, according to an aspect of this disclosure. In this aspect the ECM 200 includes each sensor and actuator located within the disclosed engine system 100. It will be appreciated that fewer or more sensors or actuators may be included in the engine system 100. Each of the sensors may be configured to sense various engine operating parameters, as further described herein. The ECM 200 also includes a data processor 202, a memory 204, a display 206, and an input device 207.

The data processor 202 may be coupled to each of the sensors, the memory 204, the display 206, and the input device 207. The processor 202 may be configured to calculate and determine various engine operating parameters and cylinder component heat flux in response to inputs from the sensors, as further described herein. Action may be taken in response to the data, including modifying the fuel supplied to the diesel supply system 102, modifying an engine speed, commencing an operation, or still other responses. Examples of processors include computing devices and/or dedicated hardware as defined herein, but are not limited to, one or more central processing units and microprocessors.

The memory 204 may include random access memory (RAM), read-only memory (ROM), or both. The memory 204 may store computer executable code including at least one algorithm for calculating engine operating parameters, at least one algorithm for calculating the heat flux for the components of the cylinder system 108, and at least one algorithm for calculating the temperature for the components of the cylinder system 108. The memory 204 may also store data and information, as described herein, which may be provided to the processor 202 when calculating the engine operating parameters and cylinder component heat flux.

The display 206 may be located on the engine system 100, remotely from the engine system 100, or combinations thereof, and configured to display various data to an operator relating to the temperature, pressure, flow rate, or still other parameters of the engine system 100. The display 206 may include, but is not limited to, cathode ray tubes (CRT), light-emitting diode display (LED), liquid crystal display (LCD), organic light-emitting diode display (OLED), or a plasma display panel (PDP). Such displays can also be touchscreens and may incorporate aspects of the input device 207. The display 206 may also include a transceiver that communicates over a communication channel.

Referring again to FIG. 1, the diesel supply system 102 may include a supply pressure sensor 208 and at least one pump sensor 210. The supply pressure sensor 208 may be configured to monitor the pressure of the diesel fuel coming from the fuel supply 112 and entering the pressure regulator 114. As the diesel fuel pressure is sensed, a signal representing a sensed value may be sent to the processor 202 and recorded in memory 204. The at least one pump sensor 210 may be configured to sense the pressure and the temperature of the fuel after the fuel exits the fuel pump 116. Each sensor 208, 210 may be configured to sense pressure and temperature over a period of time, which may be recorded in memory 204.

The air intake system 104 may include at least one air sensor 212. The at least one air sensor 212 may be configured to monitor the temperature and the pressure of the air prior to entering the intake manifold 118.

The intake manifold 118 may include at least one intake manifold sensor 214. The at least one intake manifold sensor 214 may be configured to sense the pressure and the temperature of the air and fuel mixture within the intake manifold 118. The sensed temperature and sensed pressure may include, for example, an intake manifold absolute temperature (IMAT), an intake manifold absolute pressure (IMAP), and a start of injection pressure (SOIP).

Additionally, the at least one intake manifold sensor 214 may be configured to sense the amount of the air and fuel mixture being injected into the cylinder 110 at any given period of time. For example, the at least one intake manifold sensor 214 may sense a main shot fuel quantity, an early pilot fuel quantity, a closed coupled (CC) pilot shot fuel quantity, a CC post shot fuel quantity, a post shot fuel quantify, other fuel timing quantities, or combinations thereof

The engine system 100 may also include an exhaust sensor 216 and an engine sensor 218. The exhaust sensor 216 may be coupled to the exit exhaust system 106 and configured to sense the temperature of the air-fuel mixture exiting the engine cylinder 110. The engine sensor 218 may be coupled to the crankshaft 126 and configured to sense an engine speed, an engine load, and engine timing. The engine timing may include, for example, a main shot start of injection and/or an early pilot shot start of injection.

Each of the sensors within the ECM 200 may include a signal transducer configured to sense a transmitted signal, or component of a transmitted signal. In alternative aspects, fewer of more sensors may be coupled to the engine system 100 to further indicate the amount of power used by the engine system 100, an engine output, or other information for use in controlling the engine system 100.

The processor 202 utilizes the values sensed by each of the sensors to determine the heat flux for several of the components of the cylinder system 108 using algorithms and other data or information stored in memory 204. The data or information stored in memory 204 may include physical parameters of the components of the cylinder system 108, properties of the fuel, heat transfer properties, engine operating maps, or other data relevant for determining a heat flux. The data or information stored in memory 204 may be determined prior to operation of the engine system 100, such as during a fuel system calibration process. In an aspect of this disclosure, the predetermined values (i.e. determined prior to operation of the engine system 100) may be adjusted by an operator through the input device 207, or by other means.

The physical parameters for the cylinder system 108 may include, for example, a number of engine cylinders 110, a diameter of the cylinder 110, a stroke length of the piston 124, a length of the connecting rod 127, a clearance length from the piston 124 to the cylinder head (not shown), and a surface area of the piston 124. The fuel and heat transfer properties may include, for example, a radiation heat transfer factor, a convection heat transfer factor, fuel heating value, a fuel density, pi, and the universal gas constant. In an aspect of this disclosure, fewer or more parameters may be stored in memory 204 and used in the determination of the heat flux for the cylinder system components.

The engine operating maps may include a set of data tables used to determine, for example, a heat release rate, an effective intake valve closing (IVC), a specific heat of cylinder gas (Cₚ), a specific heat for cylinder gas (Cᵥ), and a component surface temperature. Each operating map may be fixed or input by an operator and stored in memory 204 and may be created using test or laboratory data. Each operating map may be used to determine various cylinder operating parameters based on information sensed and/or input into memory 204. For example, the heat release rate may be determined as a function of the engine speed and the SOIP, and the effective IVC may be determined as a function of the engine speed. It will be appreciated that fewer or more engine operating maps may be used in the determination of the heat flux for the cylinder system components.

The algorithms stored in memory 204 may calculate the engine operating parameters and the heat flux for the cylinder components based on at least one of the inputs from the supply pressure sensor 208, the at least one pump sensor 210, the at least one air sensor 212, the at least one intake manifold sensor, the exhaust sensor 216, the engine sensor, or combinations thereof. The engine operating parameters and the heat flux may further be based on the physical parameters of the components of the cylinder system 108, the properties of the fuel, the heat transfer and fuel constants, and the engine operating maps.

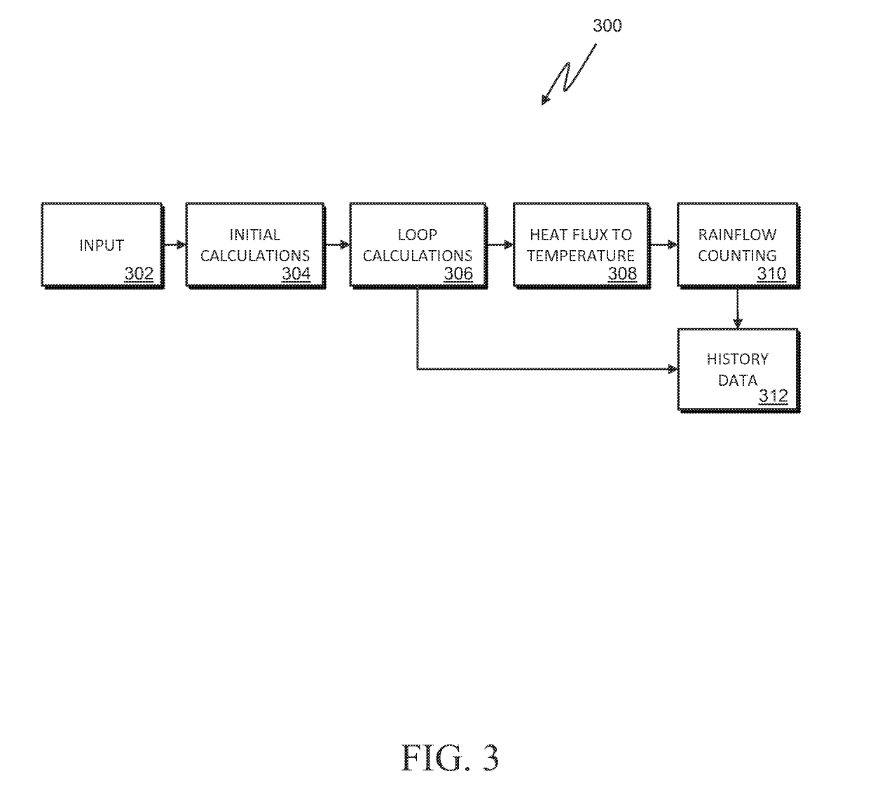

FIG. 3 illustrates a flow diagram of a method 300 configured to model the engine cylinder system 108, according to one aspect of this disclosure. At step 302, data is input into the ECM 200 and stored in memory 204. The input data may include engine operating parameters and physical parameters of the engine cylinder system 108 sensed by the sensors, input by an operator, previously stored, such as engine operating maps or other predetermined data or information.

At step 304, initial calculations may be performed, such as the calculation of the engine operating parameters based on the input data stored in memory 204. The initial calculations may be performed at any time during the operation of the engine system 100. The calculated engine operating parameters may include engine cylinder parameters and air and fuel parameters, for example, cylinder displacement, piston clearance volume, fuel temperature, mean piston speed, fuel delivery quantities, fuel delivery timing, normalized fueling, normalized power, gas density, intake manifold exhaust gas recirculation (EGR) to air ratio, and crank angle per second.

The fuel delivery quantities and the fuel delivery times may be computed for various fuel injection events. The fuel injection events may include, for example, a pilot fuel event, a CC pilot fuel event, a main fuel event, a CC post fuel event, and a post fuel event. A fuel quantity, a start of injection time, and an end of injection time may be calculated for each fuel event. The start of injection time and the end of injection time may be calculated in terms of degrees before top dead center (dbTDC) and/or degrees after top dead center (daTDC).

At step 306, after the ECM 200 receives the input data and calculates the engine operating parameters, the ECM 200 performs a set of loop calculations. The loop calculations include calculating a second set of engine operating parameters for each crank angle of the crankshaft 126 between a top dead center (TDC) position and a bottom dead center (BDC) position of the piston 124. In an aspect of this disclosure, the crank angle between the TDC and the BDC may include each angle of a complete expansion stroke and each angle of a complete compression stroke of the crankshaft 126. The input data and the previously calculated engine operating parameters are used as input into a second set of algorithms that are used to calculate the second set of engine operating parameters. The second set of algorithms may be stored in memory 204, along with the resulting second set of engine operating parameters.

The second set of engine operating parameters may include, for example, a fuel quantity injected at the crank angle, a total fuel quantity injected up to the crank angle, an unburned fuel in the cylinder at the start of the crank angle, a fuel burned during the crank angle, a total fuel burned up to the crank angle, a ratio between cylinder volume and crank angle, a mass of air at the crank angle, a density of air at the crank angle, an intake to fuel air ratio at the crank angle, and a fuel heat released at the crank angle. Each one of these parameters may be calculated for each crank angle between the TDC and the BDC positions of the piston 124 and stored in memory 204.

The second set of engine operating parameters may further include a value for convective heat transfer to each of the cylinder components and a value for radiant heat transfer to each of the cylinder components for each crank angle. The convective heat transfer and the radiant heat transfer may be determined based on the convection heat transfer factor and the radiation heat transfer factor, respectively, and a cylinder temperature and average surface temperature for each of the cylinder components. For the first crank angle, the cylinder temperature and the average surface temperature may be estimated based on the normalized power of the cylinder system 108. The heat flux for each component at the crank angle is calculated as the sum of the convective heat transfer and the radiant heat transfer to each of the cylinder component.

Prior to stepping to a next crank angle to continue calculating the second set of engine operating parameters, a total heat transfer to each cylinder component, a heat transfer per for the crank angle, a cumulative heat transfer up to the crank angle, a change in cylinder volume, a change in cylinder pressure, a final cylinder pressure, and a final cylinder temperature may be calculated. Each of the above calculations at step 306 may be performed for each crank angle. After each calculation is performed for each crank angle, a total heat flux for each of the cylinder components may be calculated by summing the heat flux for each individual component at each crank angle.

At step 308, the total heat flux for each component may be converted into a corresponding temperature for each component. Converting the total heat flux into the temperature for each component may include correlating the total heat flux for each component to a temperature for each component using an engine operating map stored in memory 204. In an alternative aspect, the conversion may also be performed by using the physical parameters of each cylinder component, such as the surface area, to calculate the temperature for each component.

At step 310, a rainflow counting algorithm, or other cycle counting algorithm, may be used to create a range-mean histogram for each of the cylinder components. The range mean histogram may include a count of a mean temperature and a temperature range. At step 312, each histogram may be stored in memory 204, in addition to other data or information resulting from steps 304 through 306, such as, for example, cylinder pressure and cylinder temperature. The histograms may be used, for example, to assess component performance and expected component life.

### INDUSTRIAL APPLICABILITY

Referring to FIGS. 1 to 3, the present disclosure provides a system and method for modeling the engine cylinder system 108. The engine cylinder system 108 includes a plurality of components and an ECM 200 operatively coupled thereto. The ECM 200 uses data stored in memory 204, such as heat flux algorithms, data from the sensors, data input by an operator, engine operating maps, or other information, to model the cylinder system 108.

The model of the engine cylinder system 108 may be embedded onto, for example, a large engine T4, or may be located remotely from the engine cylinder system 108 and configured to wirelessly receive operating data from the engine cylinder system 108. The model may be used to calculate, for example, cylinder pressure, piston temperature, head temperature, liner temperature, intake valve temperature, exhaust valve temperature, and bulk cylinder temperature. The resulting calculations from the model may be used to determine component life predictions, engine control parameters, or other parameters used for engine operation.

It will be appreciated that the foregoing description provides examples of the disclosed system and method. However, it is contemplated that other implementations of the disclosure may differ in detail from the foregoing examples. All references to the disclosure or examples thereof are intended to reference the particular example being discussed at that point and are not intended to imply any limitation as to the scope of the disclosure more generally. All language of distinction and disparagement with respect to certain features is intended to indicate a lack of preference for those features, but not to exclude such from the scope of the disclosure entirely unless otherwise indicated.

We claim:

1. A method configured to model an engine cylinder system comprising:
moving a piston of the engine cylinder system within a cylinder of the engine cylinder system;
during the moving step, sensing a first engine operating parameter;
after the sensing step, calculating a second engine operating parameter based on the first engine operating parameter; and
calculating a heat flux for at least one of a plurality of components of the engine cylinder system based on the first engine operating parameter and the second engine operating parameter.

2. The method of claim 1, further comprising:
providing at least one physical parameter of the at least one of the plurality of components to the engine control module; and
calculating the heat flux for the at least one of the plurality of components based on the at least one physical parameter.

3. The method of claim 2, further comprising:
calculating a temperature for the at least one of the plurality of components based on the heat flux and the at least on physical parameter of the cylinder.

4. The method of claim 2, further comprising:
calculating a pressure and a temperature of the cylinder based on the first at least one engine operating condition, the second at least one engine operating condition, and the at least one physical parameter of the engine cylinder.

5. The method of claim 2, wherein the at least one physical parameter of the engine cylinder includes at least one of a number of engine cylinders, a heat transfer factor, an engine bore diameter, a piston area, a piston stroke length, an engine compression ratio, engine connecting rod length, and a piston to head clearance length.

6. The method of claim 2, further comprising:
providing at least one engine operating map to the engine control module.

7. The method of claim 6, wherein the at least one engine operating map includes at least one of a heat release rate map, an effective intake valve closing map, a specific heat of cylinder gas map.

8. The method of claim 1, wherein the first at least one engine operating parameter includes at least one of an engine speed, a fuel quantity, an intake manifold pressure, an intake manifold temperature, and a start of injection time.

9. The method of claim 1, wherein the second at least one engine operating parameter includes at least one of an engine cylinder displacement, a fuel temperature at injection, a piston speed, a crank angle speed, a total fuel injected, a total fuel burned, a piston area, a liner area, and a head area.

10. The method of claim 1, wherein the at least one of the plurality of components includes at least one of the piston, a head, a liner, an intake valve, and an exhaust valve.

11. The method of claim 1, further comprising:
the step of rotating a crank shaft from a first position, in which a volume of the cylinder defines a minimum value, to a second position, in which the volume of the cylinder defines a maximum value, the crank shaft being rotably coupled to the piston, and wherein calculating the heat flux further includes calculating a heat transfer to the at least one of the plurality of components for each angle the crank shaft rotates between the first shaft position and the second shaft position.

12. The method of claim 1, wherein the first at least one engine operating parameter is sensed external to the cylinder.

13. An engine control module operatively coupled to an engine cylinder system, the engine cylinder system having a plurality of components including a piston slideably positioned within a cylinder, the engine control module comprising:
at least one sensor configured to sense a first engine operating parameter when the piston is moving within the cylinder;
a processor configured to calculate a second engine operating parameter based on the first at least one engine operating parameter, and further configured to calculate a heat flux of at least one of the plurality of components based on the first at least one engine operating parameter and the second at least one engine operating parameter.

14. The engine control module of claim 13, further comprising a display configured to illustrate an output from the processor.

15. The engine control module of claim 13, wherein a crank shaft is rotably coupled to the piston, the crank shaft being configured to rotate between a first shaft position and a second shaft position, at the first shaft position a volume of the engine cylinder is at a minimum and at the second shaft position the volume of the engine cylinder is at a maximum, wherein the processor is further configured to calculate a heat transfer to the at least one of the plurality of components for each angle the crank shaft rotates between the first shaft position and the second shaft position, and wherein the heat flux is further based on the heat transfer to the at least one of the plurality of components.

16. The engine control module of claim 13, wherein the at least one sensor is positioned external to the cylinder.

17. An engine system comprising:
a cylinder;
a piston moveably positioned within the cylinder; and
an engine control module including:
at least one sensor configured to sense a first engine operating parameter while the piston is moving within the cylinder, and
a processor configured to calculate a second engine operating parameter based on the first at least one engine operating parameter, and further configured to calculate a heat flux of the piston based on the first at least one engine operating parameter and the second at least one engine operating parameter.

18. The engine system of claim 17, further comprising:
a cylinder liner positioned within the cylinder,
wherein the processor is further configured to calculate a heat flux of the cylinder liner based on the first at least one engine operating parameter and the second at least one engine operating parameter.

19. The engine system of claim 17, further comprising:
an intake valve coupled to an inlet to the cylinder; and
an exhaust valve coupled to an outlet of the cylinder,
wherein the processor is further configured to calculate a heat flux of the intake valve and the exhaust valve based on the first at least one engine operating parameter and the second at least one engine operating parameter.

20. The engine system of claim 19, further comprising:
a crank shaft rotably coupled to the piston, the crank shaft being configured to rotate between a first shaft position and a second shaft position, at the first shaft position a volume of the engine cylinder is at a minimum and at the second shaft position the volume of the engine cylinder is at a maximum,
wherein the processor is further configured to calculate a heat transfer to the piston, the cylinder liner, the intake valve, and the exhaust valve for each angle the crank shaft rotates between the first shaft position and the second shaft position, and wherein the heat flux is further based on the heat transfer to the piston, the cylinder liner, the intake valve, and the exhaust valve.
